(19) United States
(12) Patent Application Publication
(10) Pub. No.: US 2026/0073226 A1
(43) Pub. Date: Mar. 12, 2026

(54) SYSTEMS AND METHODS FOR DATA NORMALIZATION USING FORCED PROMPTING WITH MACHINE LEARNING MODELS

(71) Applicant: Northwestern Memorial Healthcare, Chicago, IL (US)

(72) Inventor: Mozziyar ETEMADI, Chicago, IL (US)

(21) Appl. No.: 18/882,305

(22) Filed: Sep. 11, 2024

(51) Int. Cl. G06N 3/088; G06N 3/0455; G06N 3/0475

(52) U.S. Cl. CPC G06N 3/088; G06N 3/0455; G06N 3/0475

(57) ABSTRACT

Systems and methods include techniques associated with one or more machine learning systems to normalize disparate entries within one or more datasets for common data types. The one or more machine learning systems may be used to generated relationships between attribute-value pairs associated with a particular data type and then to determine, from a corpus of free-form data, individual entries for a target data type. The identified individual entries may be used to extract information from the dataset and generate a modified, clean dataset.

### BACKGROUND

### 1. Field of Disclosure

Embodiments of the present disclosure relate to systems and methods to normalize and unify data types within a free-form database. Specifically, one or more embodiments are directed toward forcing hallucinations with one or more machine learning systems to recognize correlations between data types represented by disparate free-text descriptions.

### 2. Description of Related Art

Electronic health records (EHRs) securely store and categorize different patient information. The use of EHR is intended to permit ready access to medical records from a variety of different locations for a number of providers. Many systems still use or are integrated with legacy databases, such as Massachusetts General Hospital Utility Multi-Programming System (“MUMPS” or “M”). MUMPS allows for high level data storage using free-text in a sequential format, which is often useful for patients records as patients may visit practitioners over time and visits may follow a similar structure and/or obtain similar information as conditions are monitored. However, the free-text formatting of MUMPS may allow different practitioners to enter information in different ways, even if the information is intended to represent the same data type. For example, a practitioner could write out “beats per minute” or could abbreviate “bpm” to represent the same information. While a human reading information from the database may recognize the information being associated with a common data type (e.g., a pulse), electronic evaluation may improperly categorize measurements as different data types. As a result, attempts to aggregate and clean up datasets often involve significant human intervention, such as manual review, manually generating extensive lists of potential permutations, and the like.

### SUMMARY

Applicant recognized the problems noted above herein and conceived and developed embodiments of systems and methods, according to the present disclosure, for processing stored information to identify common data types.

In an embodiment, a computer-implemented method includes receiving at least a portion of a dataset and a prompt associated with a target data type output. The method also includes generating, based at least in part on attributes of a target data type associated with the target data type output, a model output using one or more trained machine learning models. The method further includes comparing one or more model output features to one or more target data type output features. The method also includes determining the one or more model output features are not sufficiently similar to the one or more target data type output features. The method includes modifying one or more of the one or more trained machine learning models or the prompt. The method further includes generating an updated model output after modifying one or more of the one or more trained machine learning models or the prompt. The method also includes determining one or more updated model output features are sufficiently similar to the one or more target data type output features. The method includes generating a revised dataset using at least the updated model output.

In another embodiment, a processor includes one or more circuits to generate, responsive to a first prompt, a set of permutations associated with a target data type within a dataset. The one or more circuits may also receive one or more corrections associated with the set of permutations. The one or more circuits may further generate, responsive to a second prompt, a second set of permutations associated with the target datatype within the dataset. The one or more circuits may also generate, responsive to a third prompt, an updated dataset associated with the target data type, wherein the updated dataset includes at least one modified data entry of the target data type providing a different presentation type than a storage type.

In another embodiment, a computer-implemented method includes generating, responsive to a first prompt, a set of permutations associated with a target data type within a dataset. The method also includes receiving one or more corrections associated with the set of permutations. The method further includes generating, responsive to a second prompt, a second set of permutations associated with the target datatype within the dataset. The method includes generating, responsive to a third prompt, an updated dataset associated with the target data type, wherein the updated dataset includes at least one modified data entry of the target data type providing a different presentation type than a storage type.

### BRIEF DESCRIPTION OF DRAWINGS

The present technology will be better understood on reading the following detailed description of non-limiting embodiments thereof, and on examining the accompanying drawings, in which:

FIG. 1 illustrates an example environment for processing one or more datasets, in accordance with embodiments of the present disclosure;

FIG. 2 illustrates an example representation of free-form data that may be used to form one or more datasets, in accordance with embodiments of the present disclosure;

FIG. 3A illustrates an example environment for training one or more machine learning systems to normalize dataset entries, in accordance with embodiments of the present disclosure;

FIG. 3B illustrates an example environment for generating a normalized dataset, in accordance with embodiments of the present disclosure;

FIG. 4A illustrates an example representation of dataset normalization based on attribute-value pairs, in accordance with embodiments of the present disclosure;

FIG. 4B illustrates an example representation of dataset normalization based on attribute-value pairs, in accordance with embodiments of the present disclosure;

FIG. 4C illustrates an example representation of dataset normalization based on attribute-value pairs, in accordance with embodiments of the present disclosure;

FIG. 5A is a flow chart of a process for training a machine learning system to identify target data, in accordance with embodiments of the present disclosure;

FIG. 5B is a flow chart of a process for training a machine learning system to identify permutations of common data in a dataset, in accordance with embodiments of the present disclosure;

FIG. 5C is a flow chart of a process for generating an output dataset for a prompted data type, in accordance with embodiments of the present disclosure;

FIG. 5D is a flow chart of a process for generating an output dataset for a prompted data type, in accordance with embodiments of the present disclosure;

FIG. 6 is an example configuration for a computing device, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure may be directed toward systems and methods to normalize information within one or more datasets using one or more machine learning (ML) systems. Embodiments of the present disclosure may implement forced hallucinations with different ML systems, such as large language models (LLMs) to identify relationships between inconsistently labeled data types within a dataset and to clean up or otherwise normalize the dataset across each instance of the data type. For example, systems and methods may be used to evaluate datasets to identify different entries corresponding to a data type that includes different label or identification information, use one or more prompts with the model to identify correlations or relationships between different data entries, and then to generate modified dataset outputs for the entries with consistent labeling or identification for specific data types with reduced human intervention compared to manual database pruning. Similarly, embodiments may use the LLM to identify different data type presentations by leveraging sequentially stored information associated with a variety of different datasets, thereby reducing efforts to manually generate different permutations for data type representations. Accordingly, embodiments of the present disclosure may be used to address and overcome problems associated with legacy storage systems with datasets, including but not limited to EHR.

One or more embodiments of the present disclosure may use one or more trained ML systems, such as LLMs, to identify correlations between data types within datasets based on one or more prompts provided to the ML systems. By way of example, systems and methods may provide one or more prompts related to a desired data type, evaluate an output associated with the data type, and then modify and/or adjust different weights in order to train the model to identify the relevant prompts. The adjustments and/or modifications may be based on sequential information associated with the dataset, such as recognizing a particular data type follows another data type, recognizing one or more representations for a common data type, and/or combinations thereof. For example, particular units of measurements may be used for a certain data types, and as a result, those units of measurement may be used as one way to identify desired data types. As another example, particular abbreviations may be used for certain data types, and those abbreviations, when correlated to the units of measurement, may provide further indications for identifying commonality within the dataset, even if unlabeled data is presented using a variety of different types of information. Accordingly, systems and methods may be used to quickly and automatically generate improved datasets with common identifications for different data types.

Systems and methods of the present disclosure may be directed toward data normalization techniques in which datasets may include free-text information in a variety of different formats representing one or more data types. Embodiments may use one or more machine learning models to infer data types based on one or more factors of a representation, and then to provide an output dataset that has eliminated the disparity in data type formatting. At least one embodiment may pair data with one or more parameters associated with a representation and then use the one or more parameters to identify common data types. As another example, one or more embodiments may use sequence information for the dataset in order to infer a variety of data types. This information may be used to inject or otherwise provide additional information to the dataset to increase various use cases, such as injecting identifying information that may be used in a variety of downstream applications, such as medical coding, medical billing, treatment identification, and/or combinations thereof.

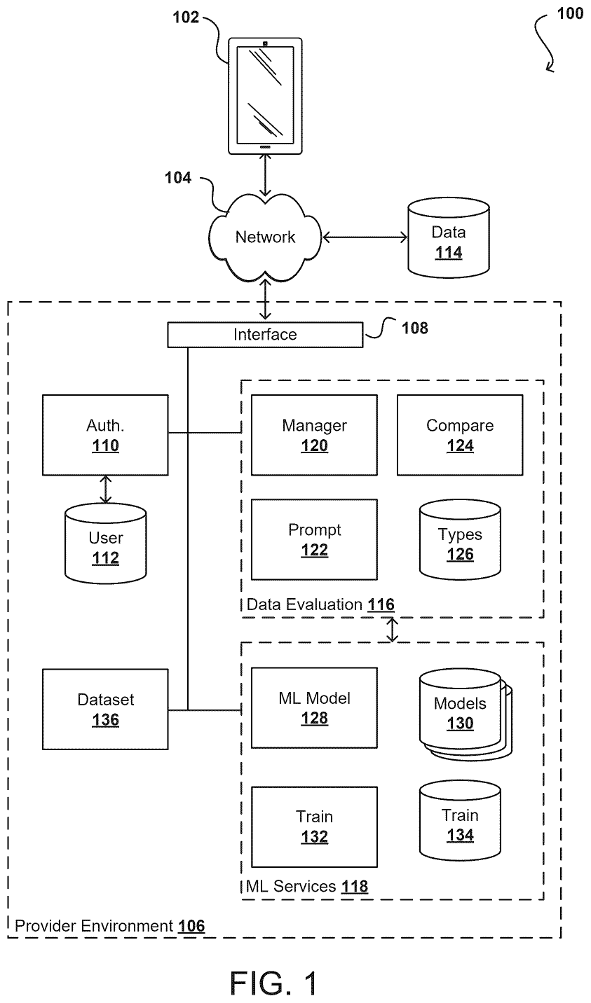

FIG. 1 illustrates an example system 100 that may be used with embodiments of the present disclosure. In this example, a computing device 102 (e.g., user device, compute device, client device, etc.) can submit a request over at least one network 104 to be received by a provider environment 106. The provider environment 106 may be an online platform provided by a service provider and/or for an affiliate, for example the environment 106 may be hosted or otherwise provided via one or more cloud resource providers on behalf of a service provider. The client computing device 102 may be a representative and/or act as a proxy for one or more users that may be submitting requests. For example, a user may navigate to one or more dashboards, web applications, landing pages, or access points using the device to submit a request, among other options. Additionally, in at least one embodiment, the client computing device 102 may act as a proxy to execute stored instructions to make and receive requests. For example, the client computing device 102 may send a request responsive to receiving one or more inputs and/or the like. As another example, a request may be transmitted as part of an automated or semi-automated workflow, which may or may not receive user interaction. For example, upon selecting a database for normalization, a workflow may be initiated to use components or features of the provider environment 106 to generate a clean or normalized database, as discussed herein. Accordingly, the client computing device 102 may be used with direct input from one or more users, from stored software instructions, from executions of various workflows, or combinations thereof.

In at least some embodiments, the request can include a request to execute one or more workflows associated with analysis and/or processing of electronic health records (EHRs), including evaluation of data (e.g., imaging data, video data, text data, audio data, combinations thereof, etc.), among other options. It should be appreciated that EHR is provided by way of non-limiting example and systems and methods may be used to evaluate a variety of different types or data in a number of different industries. As one example, sequential information that may be stored with a similar free-form structure may include financial transactions for a business that orders inventory (e.g., specifying an order by weight or by some other unit of measure). In many cases, the analysis and/or processing may include a request to access data (e.g., stored data, streaming data, etc.) and then to process the data using one or more workflows associated with the environment 106. In at least one embodiment, a selected workflow may be based, at least in part, on information provided by the computing device 102, such as a command, or based on data received by the environment 106. The network(s) 104 can include any appropriate network, such as the Internet, a local area network (LAN), a cellular network, an Ethernet, or other such wired and/or wireless network. The provider environment 106 can include any appropriate resources for accessing data or information, such as EHR, as may include various servers, data stores, and other such components known or used for accessing data and/or processing data from across a network (or from the “cloud”). Moreover, the client computing device 102 can be any appropriate computing or processing device, as may include a desktop or notebook computer, smartphone, tablet, wearable computer (e.g., smart watch, glasses, contacts, headset, etc.), server, or other such system or device.

An interface layer 108, when receiving a request or call, can determine the type of call or request and cause information to be forwarded to the appropriate component or sub-system. For example, the interface 108 may be associated with one or more landing pages, as an example, to guide a user toward a workflow or action. In at least one embodiment, the interface layer 108 may include other functionality and implementations, such as load balancing and the like.

Various embodiments of the present disclosure are directed toward processing and/or evaluation of EHR, among other features, and as a result certain data protection operations may be deployed. In at least one embodiment, an authentication service 110 may be associated with the provider environment 106 to verify credentials provided by the client device 102, for example against a user datastore 112, to verify and permit access to the environment 106. Furthermore, in at least one embodiment, verification may also determine a level of accessibility within the environment 106, which may be on an application-basis, a user-basis, or some combination thereof. For example, a first user may have access to the environment, but only have a limited set of applications that are accessible, while a second user may have access to more applications, and a third user may be entirely barred from the environment. In this manner, access may be controlled and information related to EHR may be protected.

Systems and methods may include a web-based or application-based portal that permits receipt, analysis, and evaluation of information, such as EHR, that may include multi-modal information including text data, video data, image data, audio data, and/or combinations thereof. At least one embodiment discussed here may be related toward textual information, such as information extracted from or obtained by reading one or more EHR datastores 114. The one or more EHR datastores 114 may be accessible using information provided from the client device 102 as part of the request, such as a link to an appropriate endpoint, temporary access credentials, and/or the like. Additionally, in at least one embodiment, particular data from the one or more EHR datastores 114 may be provided to the provider environment for evaluation and processes. By way of non-limiting example, systems and methods may be directed toward normalizing or otherwise simplifying various EHRs stored within legacy databases. Particular databases may be selected for processing within the provider environment 106, may be streamed to the provider environment 106, and/or combinations thereof.

In this example, a data evaluation environment 116 may be used to identify particular data types within the data and/or to manage execution associated with one or more ML services 118. In this example, the data evaluation environment 116 includes a manager 120 (e.g., data manager) that may be used to identify and prepare information from the client device 102 for processing, evaluation, and/or the like. In at least one embodiment, the manager 120 may include an interactable component that facilities operation with one or more users. In another example, the manager 120 may be used by one or more administrators to prepare an automated or semiautomated workflow associated with different operations of the data evaluation environment 116. For example, the manager 120 may be used to generate a workflow associated with one or more data normalization processes in which particular types of input information, such as EHR, is processed to identify targeted or otherwise desired information. The manager 120 may then provide different operations to a user and/or may be used to query a pre-made set of workflow operations in order to execute one or more tasks.

Embodiments of the present disclosure may implement one or more machine learning systems, which may include LLMs as one non-limiting example. In at least one embodiment, a prompt engine 122 may be used to generate different prompts that may force hallucinations from different ML systems in order to identify relationships and/or features between similar data types within different datasets. For example, the prompt engine 122 may be used to generate different prompts associated with identifying particular data types within a dataset. As one example, the prompt may be engineered in order to generate an output list of permutations for different data types that may be used to then filter or otherwise prune the data within a dataset. In at least one embodiment, the prompt engine 122 may be used to generate one or more prompts to identify a sequence of events and to recognize how different events correspond to one another and/or to determine how different events may be labeled based on events within the sequence. As an example, when a patient receives a physical, information may be collected such as blood pressure, heart rate, weight, height, etc. However, this information may be added to EHR in a variety of different ways, including in different orders, using different abbreviations, and/or the like. Embodiments of the present disclosure may be used to identify how information is grouped or otherwise correlated in order to extract relevant data types, even when data types are not labeled or otherwise identifiable using common information. By way of example, Table 1 illustrates different ways that information associated with blood pressure may be presented for the same value.

TABLE 1
Data Recordation for Blood Pressure Measurements

| DATA TYPE | NAME | VALUE |
|---|---|---|
| Blood Pressure | Blood Pressure | 140/67 |
| Blood Pressure | NM AN NIBP Blood Pressure | 140/67 |
| Blood Pressure | Anesthesia Blood Pressure | 140/67 |
| Blood Pressure | BP | 140/67 |

Embodiments of the present disclosure may use the prompt engine 122 to generate one or more inputs to recognize data pairings in order to correlate the different names provided to the data type, in this example blood pressure, in order to normalize and/or otherwise label or simplify different datasets. As discussed herein, normalizing datasets may enable faster retrieval of relevant information while also reducing storage capacity and simplifying entry procedures.

The illustrated data evaluation engine 116 includes a comparison engine 124 that may be used to permit a machine reviewer to compare outputs associated with various input prompts in order to tune or otherwise adjust the prompts using the prompt engine 122. For example, a prompt may be provided to an ML system to output a list of permutations for blood pressure from a set of potential options. The comparison engine 124 may be used to evaluate and compare the output to the potential operations to determine whether items have been missed and/or improperly added, and then to tune or otherwise adjust the prompt in order to identify the full list in a later evaluation. For example, the prompt may include additional information such as generating all outputs that include a “/” symbol, while also including some indication associated with blood pressure, in order to readily identify the relevant information. Similarly, the comparison engine 124 may be used by human reviewers to evaluate or spot check different ML outputs. It should be appreciated that the comparison may be based on a variety of factors that may vary or otherwise be selected based on one or more factors, such as factors of the data being evaluated, target output information, and/or combinations thereof. For example, comparison of data and/or model outputs may include linear comparison methods, non-linear comparison methods, machine learning comparison methods, and/or combinations thereof. Similarly, the comparison may be used to determine a similarity or sufficient similarity between one or more outputs and targets, where similarity may also be defined or otherwise categorized by the data type, target output information, and/or combinations thereof. For example, similarity may be based on similar numerical values, similar distributions of numerical values, similar spelling, similar data presentation formats, and/or combinations thereof.

Embodiments may store the different prompts within a type datastore 126 to generate one or more automated or semi-automated workflows for identifying data types within a dataset. For example, a particular workflow associated with one or more prompts may be identified as useful for extracting certain types of information from a dataset, and therefore, storing the associated prompts and/or information for the prompts may facilitate executing workflows to automate data normalization and evaluation for a variety of datasets.

One or more embodiments may be directed toward the ML services 118, that may include one or more LLMs or other types of models, which may be transformer-based models, convolutional neural networks, recurrent neural networks, and/or combinations thereof. Various embodiments associated with the ML services 118 may include execution of different software instructions based, at least in part, on a request received from the user device. In this example, an ML model 128 may be selected from one or more models of a model datastore 130, which may include a set of models that may be trained for a domain and/or are general or foundational models that may be used with embodiments of the present disclosure. These models 128 may be trained and or execute using one or more different datastores, which may include training data, model parameters, model settings, rules, and/or the like. The models in the model datastore 130 may undergo training using a training engine 132, which may use training data from a training datastore 134, which may include outputs or tagged information based on the prompts. The training data, which may be labeled or unlabeled, and also may be augmented or otherwise influenced by one or more human reviewers, but it should be appreciated that raw training data may be used with one or more self-supervised learning processes. Accordingly, models may be trained for specific use cases and/or a general model may be trained for a specific domain, such as a medical domain or a finance domain, among other options. The model 128 may output one or more datasets 136, which may also be referred to as normalized datasets, that may then be used for a variety of applications, such as processing EHR for billing or coding purposes, analyzing trends, research, and/or the like.

In at least some embodiments, language models, such as LLMs or visional language models (VLMs) and/or other types of generative artificial intelligence (AI) may be implemented as part of the ML service 118. These models may be capable of understanding, summarizing, translating, and/or otherwise generating text (e.g., natural language text, labels, etc.), images, video, and/or the like, based on the context provided in input prompts or queries. The models (e.g., LLMs, VLMs, etc.) may be used for summarizing textual data, analyzing and extracting insights from data (e.g., textual, image, video, etc.), and generating new content (e.g., text, image, video, audio, etc.). Various embodiments may also include single modality models (e.g., exclusively for text or image processing) or multi-modality models (e.g., receiving combinations of inputs). For example, VLMs may accept image, video, audio, textual, 3D design, and/or other inputs data types and/or generate or output image, video, audio, textual, 3D design, and/or other output data types.

Various types of architectures may be implemented in various embodiments, and in certain embodiments, architecture may be technique-specific. As one example, architectures may include recurrent neural networks (RNNs) or long short-term memory networks (LSTMs), transformer architectures (e.g., self-attention mechanisms, encoder and/or decoder blocks, etc.), convolutional neural networks (CNNs), and/or the like.

In various embodiments, the models may be trained using unsupervised learning, in which models learn patterns from large amounts of unlabeled training data (e.g., text, audio, video, image, etc.). Furthermore, one or more models may be task-specific or domain-specific, which may be based on the type of training data used. Additionally, foundational models may be used and then tuned for specific tasks or domains. Some types of foundational models may include question-answering, summarization, filling in missing information, and translation. Additionally, specific models may also be used and/or augmented for certain tasks, using techniques like prompt tuning, fine-tuning, retrieval augmented generation (RAG), adding adapters, and/or, the like.

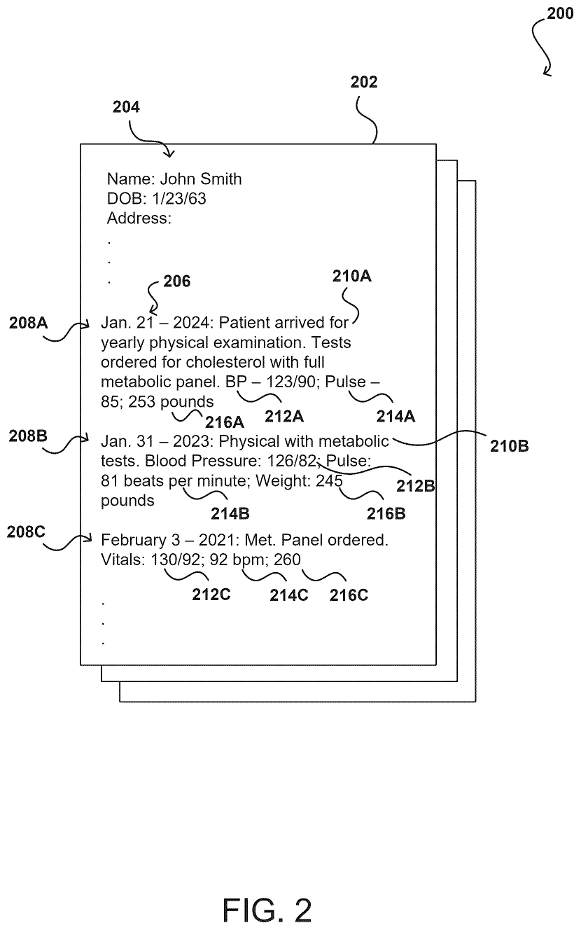

FIG. 2 illustrates an example representation 200 of EHR that may be associated with embodiments of the present disclosure. In this example, a record 202 includes information associated with a patient, which may include identifying information 204, such as the patient name, address, date of birth, and/or the like. Various embodiments may also anonymize the patient by obfuscating identifying information, for example, by using random characters or a securely assigned identification number, among other options.

Information within the record 202 is formatted sequentially with dates 206 for different text blocks 208. For example, the text block 208A corresponds to Jan. 21, 2024 while the text block 208B corresponds to Jan. 31, 2023, and so forth. This record may be used with EHR to track patient visits over time, providing an overview of changes or updates to conditions. Additionally, in this example, information is provided with a cadence or similar structure, but it should be appreciated that other embodiments may not provide such a uniform or semi-unform data input structure. For example, each of the text blocks 208A-208C in this example are associated with an annual physical for a patient. However, as shown, different practitioners provide different input information such that the information is inconsistent with respect to identifying features such as data type, units of measurement, and so forth.

In the example, the text block 208A begins with the date, then proceeds to provide a reason 210A for the visit, a blood pressure reading 212A, a pulse reading 214A, and a weight 216A. As shown, the blood pressure reading 212A is abbreviated with “BP” instead of spelling out blood pressure. Additionally, no units of measurement are provided for the pulse reading 214A. Moreover, the weight 216A is not labeled. While a human reviewer could likely identify the information within the text block 208A, is may be difficult to extract and normalize the data found within the text block 208A without significant manual review and processing. This problem is exacerbated when looking at the inconsistencies with text blocks 208B and 208C.

As shown, the text block 208B also includes the date and the reason 210B for the visit, along with the blood pressure reading 212B, the pulse reading 214B, and the weight 216B. However, the data is not consistent when compared to the text block 208A. For example, the blood pressure reading 212B spells out “blood pressure” instead of the abbreviation used in the text block 208A. Additionally, a unit of measure for the pulse reading 214B is provided. Another difference is that “weight” is specifically labeled for the weight 216B. The text block 208C illustrates many of the same differences and inconsistencies. For example, there is no reason for the visit associated with the text block 208C and only an indication of labs ordered is provided. Additionally, none of the blood pressure reading 212C, the pulse reading 214C, or the weight 216C are labeled in the text block 208C. Furthermore, an abbreviation is used for the pulse reading 214C and there are no units of measurement for the weight 216C.

The inconsistency between information within a common file may be worse within a larger dataset, which may include information for any number of persons that was edited and/or changed by any number of practitioners, leading to a large number of potential combinations of different data type configurations. As a result, attempts to consolidate and/or modernize these datasets, and/or use the information within the datasets for analysis, may be difficult, often using manual review to onerously go through the records, identify salient information, and then reformat the information with a common format. Embodiments of the present disclosure may address and overcome these problems by using one or more ML systems, such as LLMs as one example, to identify correlations between different data pairs to extract and identify different data types within the datasets, even when the data types present information in an inconsistent way. For example, systems and methods may be used to identify and extract attribute-value pairs within a given dataset corresponding to a particular data type. The attribute-value pairs may be extracted from free-form text and may be normalized and provided as an output in a given format. In at least one embodiment, one or more workflows may execute to identify desired attribute-value pairs within a corpus of information.

One or more embodiments of the present disclosure may be directed toward attribute value extraction to identify attribute-value pairs in free-form text, such as EHR. It should be appreciated that embodiments may refer to free-form text, but other data structures may also be used within the scope of the present disclosure. In at least one embodiment, the extracted attribute values may be normalized to be represented on single, attribute-specific scales. For example, a set of desired attributes may be established for a given data type (e.g., a measurement type, a value, a unit of measurement, a date, etc.) and then the data type may be used with downstream processing tasks. Embodiments address and overcome problems with existing methods that rely on large amounts of domain-specific training to learn extraction rules, labeling operations, and/or human intervention. Systems and methods may be used to identify sequences of tokens that form values associated with desired or target attributes and then normalize the values per one or more desired output formats.

Systems and methods may use one or more ML systems, such as LLMs, that may be foundational models and/or domain-specific trained models to extract attribute-value pairs from a corpus of information. In at least one embodiment, one or more prompt templates may be generated for a specific data type and/or use case. For example, a prompt template used for EHR may be different from a prompt template used for financial information, which may further be different from a template used for other domains. At least one embodiment may provide a prompt to extract attributes using a target structure. The structure may include information such target output formats, a task description (e.g., instructions for extraction), and/or a task input (e.g., instructions to evaluate certain datasets). Embodiments may also be directed toward one or more training processes to develop prompts by forcing hallucinations in order to identify connections between different attribute-value pairs to modify training weights for the models and/or to change different input prompts. For example, prompts may request certain attribute-value pairs and associated rationale and/or reasons for grouping different attribute-value pairs. A reviewer may then analyze the output of the model to determine whether different relationships may be adjusted and/or modified in order to identify different attribute-value pairs and/or to make it easier to extract desired information from the corpus of information.

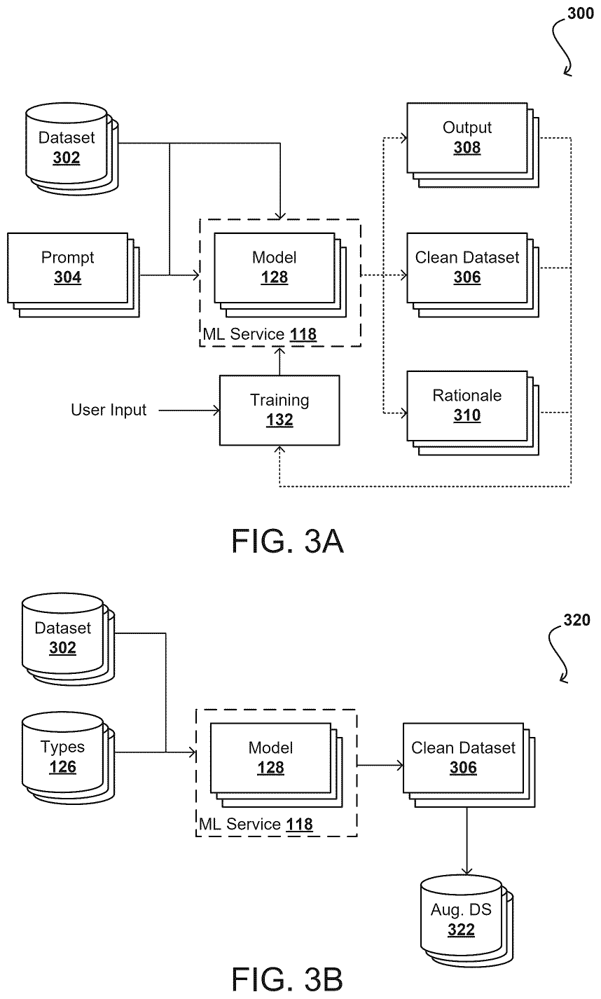

FIG. 3A illustrates an example environment 300 that may be used with embodiments of the present disclosure. In this example, a user may interact with one or more models 128 associated with one or more ML services 118 to process a dataset 302, which may be stored in one or more datastores 114 (FIG. 1), such as to normalize and/or extract information from the dataset 302. One or more embodiments may be associated with a pipeline for training and/or adjusting weights for the one or more models 128 using, for example, a training engine 132 responsive to information generated by the one or more models 128.

In this example, the one or more models 128 may be trained using one or more datasets, for example for a particular domain and/or tuned for a certain use case, and then a user device may be used to provide one or more prompts 304 to the one or more models 128. For example, the one or more models 128 may be LLMs and/or VLMs, among other options. As discussed herein, the prompts 304 may be used to train the one or more models 128 to normalize or otherwise extract information from the dataset 302. Normalization may refer to one or more data processing techniques to transform values associated with attributes to a common scale without distorting differences between the values. For example, normalization associated with embodiments of the present disclosure may refer to a process to identify information within a corpus associated with a common attribute, even if presentation of the attribute and/or the values are different. Accordingly, while embodiments may refer to adjusting a scale, systems and methods may refer to units of measurement as the scale, labels to identify certain data types as the scale, and/or combinations thereof.

Systems and methods of the present disclosure may be used to force one or more hallucinations associated with the one or more models 128 in order to identify relationships between data entries, which may be used to adjust prompts and/or train the one or more models 128 to more effectively identify common data types within a dataset. Hallucinations may refer to seemingly accurate output data from one or more LLMs that may be associated with an inability to distinguish false information, training data errors, incorrect input prompts, overfitting when training, and/or combinations thereof. In at least one embodiment, hallucinations may incorrectly identify information from an input dataset, generate conflicting information from a dataset, and/or generate partial responses.

As discussed herein, machine learning models such as LLMs, which may be transformer-based models, may be trained on one or more datasets to predict missing words or next words within a sentence or a sequence. At training, the quality of the predicted word is dependent on the quality of the training data, and therefore, if the training data includes errors, it is likely that the model will generate errors at inference. Additionally, various models may operate in an autoregressive manner such that future predictions are based on prior predictions. Systems and methods may leverage these features of LLMs to force hallucinations in order to observe and/or adjust relationships between sequential information within one or more datasets, thereby enabling rapid and precise permutation identifications to facilitate dataset normalization and adjustment.

In this example, the one or more prompts 304 may include a request to execute a certain task and/or to provide identifying information, among other options. As an input, the one or more models 128 may receive the dataset 302, which may be a selected or limited portion of an entire dataset and/or an entire dataset, along with a prompt 304 to execute one or more actions associated with the dataset 302. For example, the prompt 304 may request the model to generate all permutations associated with blood pressure or to output billing codes for a particular procedure, among other options. In at least one embodiment, the prompt 304 may also provide an output format, which may include a request to generate a clean dataset 306, generate a desired output 308, and/or to provide rationale or reasoning 310 associated with content generation. It should be appreciated that the various outputs of the one or more models 128 are provided by way of non-limiting example and that different prompts 304 and/or models 128 may produce different output sets.

One or more embodiments may be used to further train the one or more models using the training engine 132. For example, output information may be provided to the training engine 132 where one or more user inputs may be used to modify and/or adjust data to retrain or otherwise fine tune the one or more models 128. As an example, the user may evaluate the output 308 to compare the permutations for the prompt to at least a subset of the dataset 302 to determine whether or not permutations were missed or incorrectly generated. As another example, the clean dataset 306 may be evaluated to determine whether or not information is missing, improperly added, formatted incorrectly, and/or the like. Additionally, evaluation of the rationale 310 may be useful in identifying the relationships recognized by the one or more models 128 between the input data to determine whether or not prompts should be modified. For example, the rationale 310 may indicate that certain information was identified because other information was presented within a certain number of lines or characters. The user may evaluate this rationale to determine whether the relationship is a one-off or inconsequential relationships. As one example, during a routine physical, certain information may always or substantially always be obtained by a practitioner. Accordingly, it may be useful to identify a relationship between an activity (e.g., a physical) and a source for different information. In this manner, the one or more models 128 may be retrained and/or the one or more prompts 304 may be adjusted and fine tuned to drive the one or more models 128 to identify the desired output information.

Various embodiments of the present disclosure may be used to identify different prompts 304 and/or training information that may be used to cause the one or more models 128 to output a desired result. As discussed herein, because the output information is known (e.g., by evaluating the dataset 302 or a portion thereof), the prompt 304 may be used to encourage hallucinations to draw relationships between information within the dataset 302 because the results can be checked and then tuned. For example, different prompts 304 may be evaluated and then adjusted to determine whether output information corresponds to a desired set. Once the prompts 304 have been tuned and/or the one or more models 128 are tuned, then larger quantities of data may be processed by the one or more models 128 with less or no human intervention to rapidly identify information within the dataset without the laborious tasks of evaluation, establishing a list of permutations, testing the list, and then repeating the process over large quantities of data. Accordingly, systems and methods may be used to overcome problems with traditional evaluation by reducing manual human inputs and also automatically generating different permutations for various attribute-value pairs.

FIG. 3B illustrates an example environment 320 that may be used with embodiments of the present disclosure. In this example, the one or more models 128 may be trained and deployed at part of a managed service or the like that may include execution of one or more workflows. For example, different prompts or desired evaluations from the type datastore 126 may be provided as in input with the one or more datasets 302 for evaluation by the one or more models 128. The one or more models 128 may be used to generate the clean datastore 306, which may include a set of information generated responsive to one or more prompts that are associated with the type datastore 126. The clean dataset 306 may then be used to build an augmented dataset 322, which may be used for downstream processing tasks and/or the like.

Systems and methods of the present disclosure may be deployed to evaluate and extract information from one or more datasets associated with attributes and/or values corresponding to a common data type that may be stored or otherwise labeled within the dataset with inconsistencies across a variety of entries. As discussed herein, one or more embodiments may be associated with information input as free-form text from a variety of practitioners that may follow different conventions and/or styles, thereby providing inconsistent data storage schema. Because the data is stored with inconsistencies, it may be difficult to evaluate, parse relevant information, and/or generate datasets that may be used for evaluation and/or diagnostic purposes. Embodiments of the present disclosure may implement one or more ML models to evaluate information within a dataset to determine permutations associated with a common data type and then generate one or more prompts and/or be incorporated into training data to enable one or more workflows to evaluate large data sets, identify attribute-value pairs associated with target data types, and to output clean datasets, among other options. In this manner, human intervention may be reduced for pruning or otherwise evaluating datasets, storage requirements may be decreased by targeting and storing data with a common structure, and end use cases for the data may be increased.

One or more embodiments may include information that is presented as a time-ordered list, which may also be referred to as sequential data. For example, referring to the non-limiting domain of EHR, time-ordered data may refer to different entries on a patient chart associated with care or treatments provided over a period of time. A patient may receive monthly or yearly treatment for certain conditions or preventative care. However, because the free-form text is often devoid of a standard storage schema, it may be difficult to track changes over time or to use the information for richer analysis. Embodiments of the present disclosure address and overcome such problems by collapsing equivalences within time-ordered lists to identify and extract target information, even when the data is not labeled or sorted in pre-determined categories. For example, one or more models may be deployed to recognize relationships and/or dependencies within datasets and may be used to predict events and/or information based on information within the dataset. As one example, if a patient receives an operation for a condition, one or more models may be used to predict subsequent treatment or care events, such as post-operative data collection, which may be used to normalize data over a series of time-steps, even when data is entered as free-form text by a variety of different care givers. One or more embodiments may reduce manual effort associated with identifying information within datasets to quickly and accurately unify information associated with common or related data types. In this manner, embodiments may collapse dependencies for different attributes into a single or common representation and then generate one or more outputs, such as a cleaned dataset, which may be used for evaluation or other downstream operations.

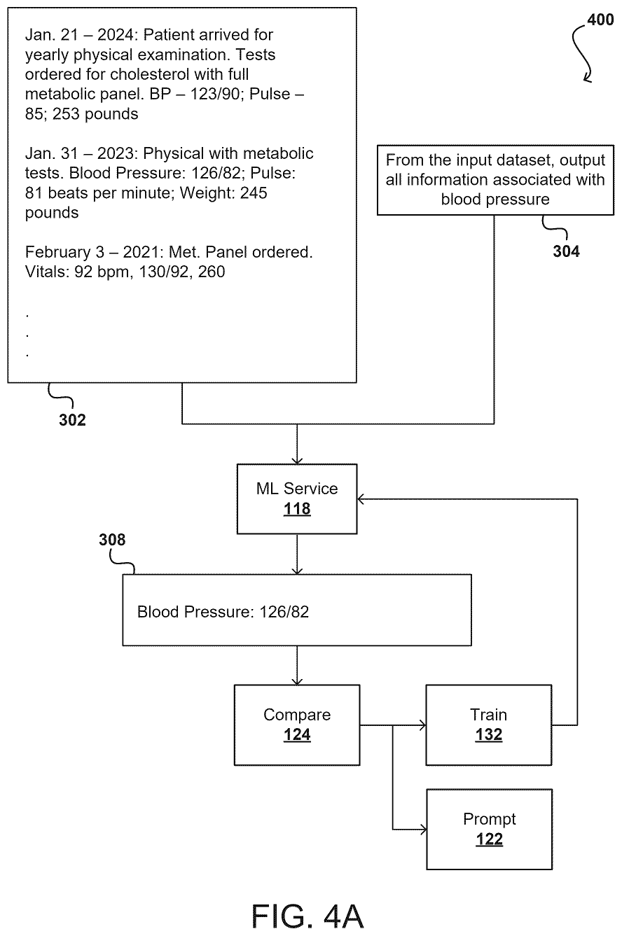

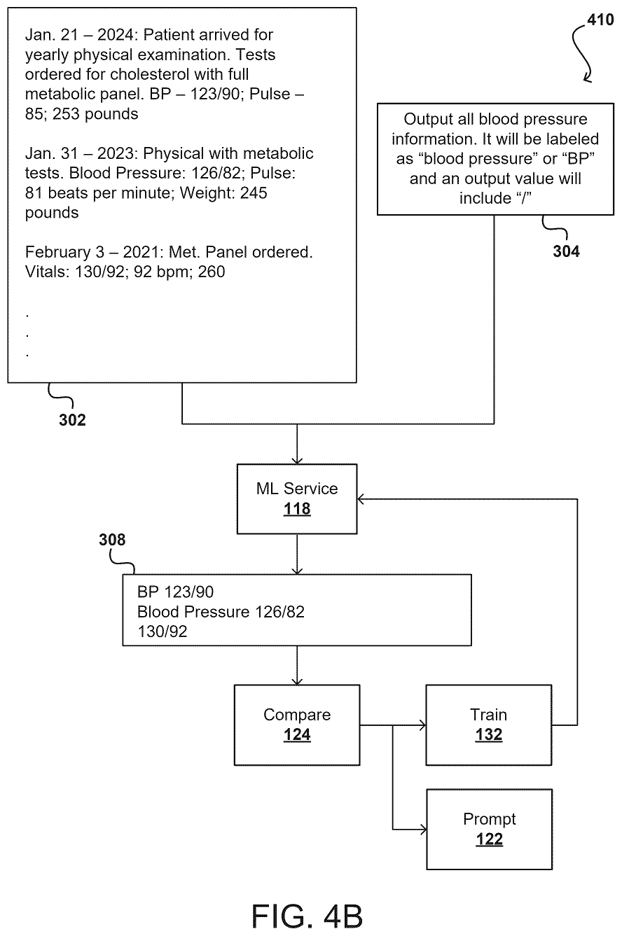

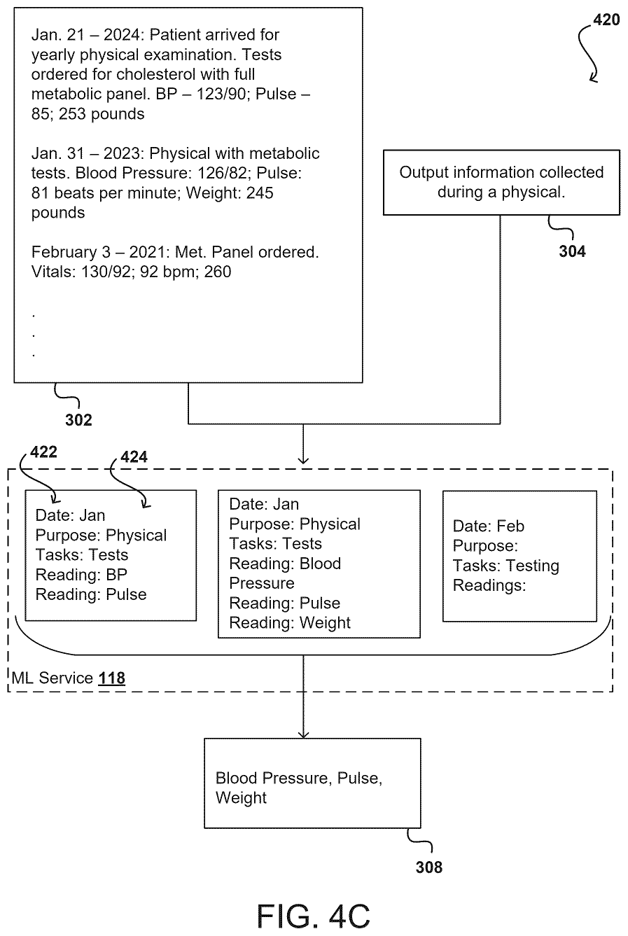

FIG. 4A illustrates an example environment 400 that may be used with embodiments of the present disclosure. In this example, the ML service 118 may be used to evaluate one or more datasets 302 based, at least in part, on the prompt 304. As discussed herein, the ML service 118 may incorporate one or more ML models, including but not limited to LLMs, that may be used to provide an output responsive to the one or more inputs. It should be appreciated that multiple models may be used within the scope of the present disclosure and that one or more models may be selected based on properties of the one or more datasets 302 and/or the prompt 304. The prompt 304 may be a user-generated prompt, such as during a training and evaluation step, or may be part of a workflow. In this example, the dataset 302 includes a time-ordered list of information associated with EHR for a patient. As discussed herein, the information is presented as free-form text and particular information is not labeled or formatted in a consistent way. For example, regarding blood pressure, different labels are used (e.g., “BP” or “blood pressure”). As another example, information may not be provided in a consistent order, as shown with the February 3 entry where pulse is provided before blood pressure. Other inconsistencies illustrated within the sample for the dataset 302 include using semi-colons to separate portions of data and using commas to separate other portions of data. Accordingly, identifying and extracting relevant information may be challenging without substantial manual efforts. Embodiments of the present disclosure may use the prompt 304, among other features, with one or more models of the ML service 118 to identify permutations for a given data type for identification of different attribute-value pairs.

The prompt 304 in FIG. 4A includes a request to identify all information associated with blood pressure. As an input, the model associated with the ML service 118 may receive the dataset 302 and the prompt 304 and then generate the output 308. The output 308 may be evaluated at a comparison engine 124 and it may be determined that the output 308 has failed to identify each instance of blood pressure information for the dataset 302. Based on the comparison, the model may be retrained using the training engine 132 and/or the prompt 304 may be adjusted or new prompts may be added using the prompt engine 122.

As shown in the illustrated example, the prompt 304 was associated with a request 118 to illustrate different permutations associated with blood pressure, but the selected model was only able to identify information that directly used the phrase “blood pressure” which missed two-thirds of the information in the dataset 302. The accuracy rate would be too low for meaningful use with evaluation large datasets. Systems and methods may be used to identify relevant permutations and then collapse differences into a common representative form.

FIG. 4B illustrates an example environment 410 that may be used with embodiments of the present disclosure. In this example, the prompt 304 is provided to the ML service 118, along with the dataset 302, to include information associated with different permutations for a desired category or data type. For example, the prompt 304 provides different example labels for blood pressure data and also provides a potential value format for blood pressure. With this revised prompt 304, the ML service 118 may execute to provide the output 308 including each instance of blood pressure within the dataset 302. The comparison engine 124 may be used to further evaluate the output 308 against the dataset 302 to determine whether or not additional training and/or prompt engineering may be useful to update or improve the output 308.

The embodiment of FIG. 4B illustrates an improved identification rate for the target information compared to FIG. 4A. For example, different labels representative of blood pressure were captured and the format of the value (e.g., including “/” between two numbers) was used to extract unlabeled information. Furthermore, different relationships may also be drawn to further distinguish blood pressure information, or any other target data type. Continuing with the example of blood pressure, the including the “/” may still capture information for other measurements, and therefore, associated data for blood pressure may further be linked to ranges for the numbers around “/”. By way of example, if a normal blood pressure reading is 120/80, the ranges may include 80-150/50-110. Similarly, embodiments may be used to infer ranges based on other information within the dataset. For example, if a clinician wrote “normal bp” into the EHR, systems and methods may be used to determine that “normal” for blood pressure equates to a range of approximately 120-125/80-85. In this manner, relationships may be drawn between inconsistently labeled information to provide consistent output data.

FIG. 4C illustrates an environment 420 that may be used with embodiments of the present disclosure. In this example, the prompt 304 requests an output corresponding to information that is collected during a physical. In operation, the ML service 118 may use one or more models to evaluate the dataset 302 and extract relationships between portions of the dataset 302 to develop attribute-value pairs associated with physicals. For example, different attributes 422 are extracted from the dataset 302 along with their respective values 424. In this example, the attributes 422 are identified by evaluating content within the associated time period for the “physical” as demonstrated by the attribute associated with physical. Systems and methods may be used to recognize and/or generate relationships between the different portions of text, such as inferring that physicals occur near January of each year, inferring that “metabolic tests” are associated with physicals, and/or identifying relevant information across a number of different portions of text. In this example, different readings are identified such as “BP” or “Pulse.” As shown in this example, there may not be sufficient information or relationships initially developed with the physical that occurred in February. However, systems and methods may use the output 308 to determine how relationships were generated and then may adjust or otherwise prompt the model to form one or more new or additional relationships. For example, the February physical includes “vitals” which may be used to draw a relationship to the “reading” attributes with the other physicals due to the values provided as vitals. As a result, subsequent requests for data associated with physicals may update the relationships to provide the vitals information from February.

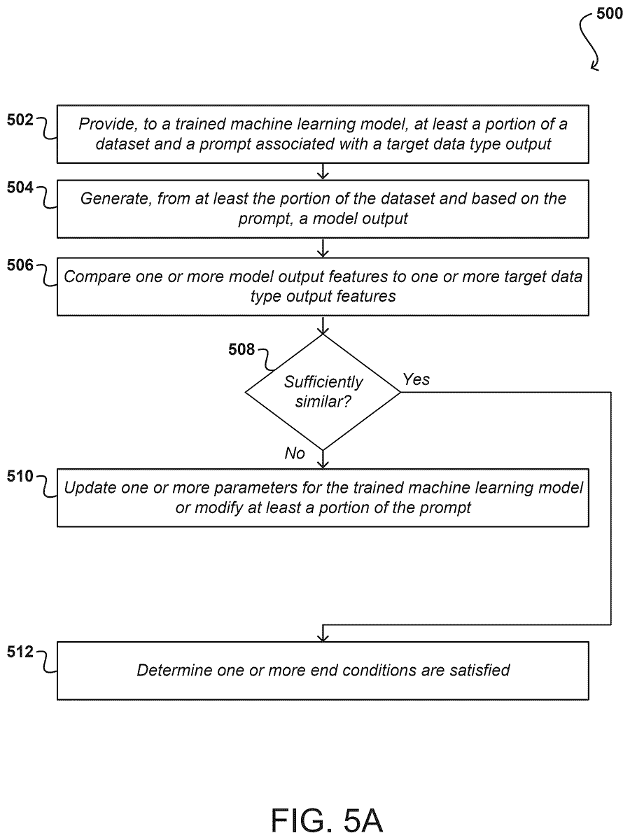

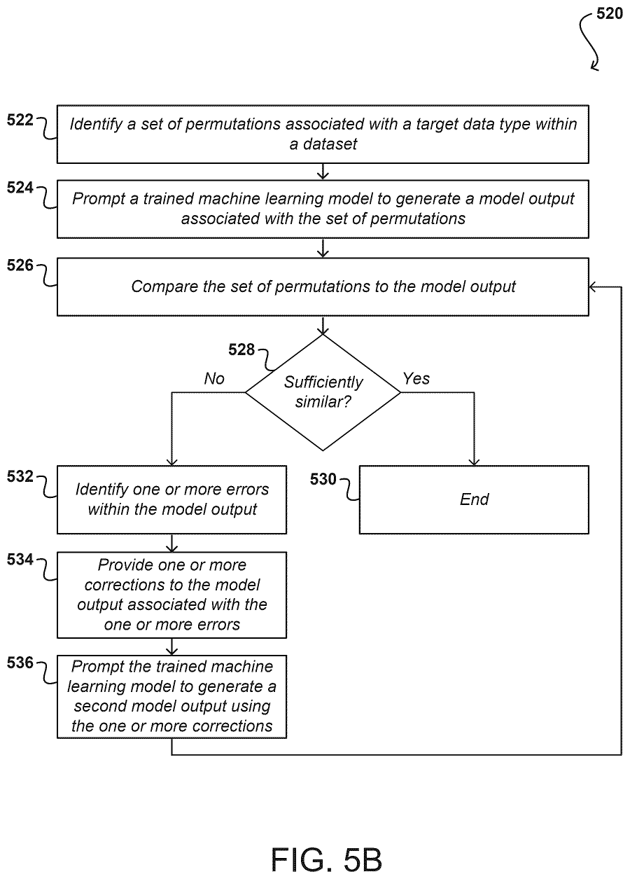

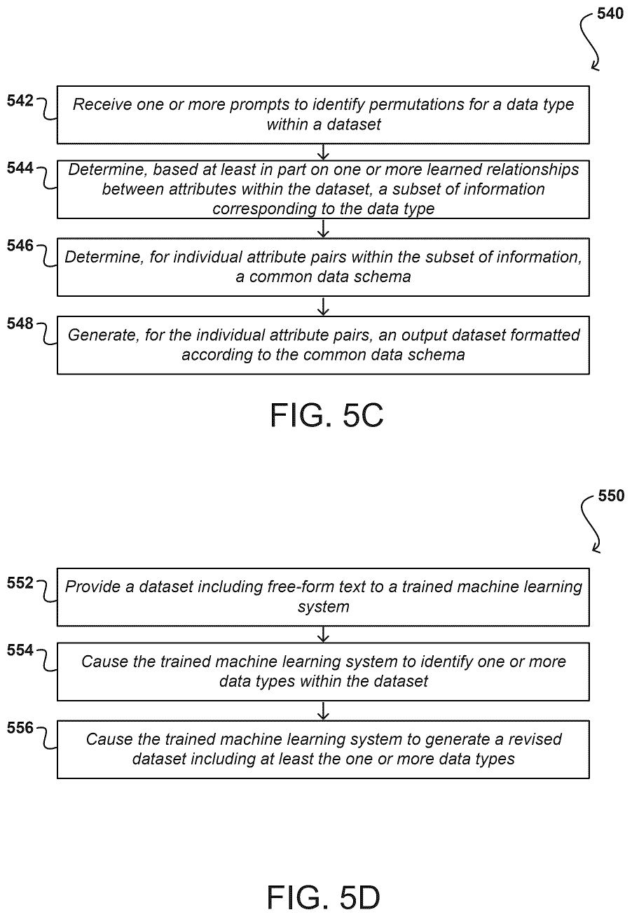

FIG. 5A illustrates an example flow chart for a process 500 for evaluating a machine learning output for a prompted target data type output. It should be appreciated that steps for the method may be performed in any order, or in parallel, unless otherwise specifically stated. Moreover, the method may include more or fewer steps. In this example, a prompt is provided to a trained machine learning model along with at least a portion of a dataset 502. The dataset may be associated with free-form text and may be sequential data, such as EHR. The prompt may be associated with a desired output for a given data type, such as information within the EHR that may be stored inconsistently due to lack of labels or a consistent storage schema structure. In at least one embodiment, systems and methods of the present disclosure may present the prompt at training time in order to evaluate model outputs and then make one or more modifications to tune the model to generate the desired target data type output.

This example includes using a model output using the trained machine learning model with the prompt and the dataset as an input 504. For example, the model may be a LLM that may evaluate one or more tokens within the dataset and then generate the model output by predicting a next sequence of tokens. Other types of models may also be used within the scope of the present disclosure. The model output may be compared to the target data type output 506. For example, one or more features for the model output may be compared to one or more features for the target data type output. The features may be associated with attribute-value pairs for the data within the dataset. By way of example, an attribute value pair may include target attributes for a given data type, such as a date for a procedure (e.g., attribute=date, value=Jan. 5, 2024). As discussed herein, dates, as one example, may not be presented consistently within the dataset. For example, one user may use MM/DD/YYYY while another uses DD/MM/YYYY and still another uses MM/DD/YY and yet another user may write out dates as MONTH DD, YYYY. As a result, it may be difficult to identify and properly correlate and collapse related information into a singular representation. Embodiments of the present disclosure may address and overcome these problems via the comparison between the features of the model and target data type output. In at least one embodiment, comparisons may be performed on the data, on a numerical value correlated to the data, on a data format, and/or combinations thereof. By way of non-limiting example, comparing model output features may include classifying outputs based on one or more factors, such as including a date. Comparison may include a variety of different methods to analyze different components of the output features, including linear methods, non-linear methods, machine learning methods, and combinations thereof.

The comparison may be used to make a determination regarding whether or not the one or more features are sufficiently similar between the model output and the target data type output 508. Sufficient similarity may be based on one or more metrics, such as a comparison between a number of identified objects compared to unidentified objects, a number of missed objects, percentages of recognized/missed objects, and/or the like. The metrics may be established using numerical methods, such as looking at similarity for numerical values or value distribution, or may be based on classifications or non-numerical comparisons, such as comparing spelling or other textual features. If the outputs are not sufficiently similar, one or more model parameters or the prompt may be updated 510. For example, the model may be retrained or may have weights adjusted. Additionally, or alternatively, the prompt may be changed to target different information and/or to provide more guidance for selecting the output information. If the outputs are sufficiently similar, then an end condition may be determined as having been satisfied 512, which may cause the prompt to be stored and saved for evaluation of datasets associated with the target data type. In this manner, one or more models may be trained to identify inconsistently stored information within a free-form dataset for particular target data types.

FIG. 5B illustrates an example flow chart for a process 520 for training a machine learning system. In this example, a set of permutations are identified associated with a target data type within a dataset 522. For example, target permutations may be associated with different formulations for presenting common underlying information, such as using long-form instead of abbreviations. In at least one embodiment, the permutations are identified by one or more human reviewers. In one or more embodiments, the permutations are identified by a machine learning system. Moreover, the permutations may be identified by both the one or more human reviewers and the machine learning system. A trained machine learning model may be prompted to generate a model output associated with the set of permutations 524. For example, the model output may correspond to a list of information associated with the permutations, which may further include instructions to format the information.

In at least one embodiment, the set of permutations may be compared to the model output 526. Comparison may include, at least in part, evaluating the different permutations against the model output to determine whether a sufficient number of permutations have been identified and/or to determine whether information is wrongly identified, among other combinations of evaluations. Various metrics may be established during the comparison, such as percentage of correct identifications, a percentage of incorrect identifications, and/or the like. It may be determined whether or not the set of permutation is sufficiently similar to the model output 528. If so, then the training process may end 530, for example, based on one or more stop criteria.

If the set of permutations are not sufficiently similar to the model output, then one or more errors may be identified 532 and the one or more errors may be used to provide corrections to the model output 534. For example, incorrect information may be identified and marked and/or missing information may be added, among other options. The one or more corrections may then be used to generate a new prompt and/or adjust weights of the model to generate a second model output 536. Training may continue until some stop condition is reached.

FIG. 5C illustrates an example flow chart for a process 540 for generating a clean output dataset for a target data type. In this example, one or more prompts are received to identify permutations for a data type within a dataset 542. For example, a user may provide a prompt to a trained machine learning system to identify instances within a dataset associated with a target data type. One or more learned relationships for the machine learning model may be used to determine a subset of information corresponding to the data type 544. The relationships may be based on attribute-value pairs for a given dataset and/or based on how different attributes are presented within a sequentially stored free-form dataset. In at least one embodiment, a common data schema may be determined for individual attribute pairs within the subset of information 546. For example, a target output data schema may be determined from the one or more prompts. An output dataset may then be generated using the individual attribute pairs including the common data schema 548. In this manner, information may be identified and extracted from a dataset based on the data type, even if the information is stored with inconsistent data schema.

FIG. 5D illustrates an example flow chart for a process 550 for generating a revised dataset. In this example, a dataset including free-form text is provided to a trained machine learning system 552. The trained machine learning system may be prompted to identify one or more data types within the dataset 554. The one or more data types may be associated with a set of pre-established prompts and/or based on targeted, tuned training data. Thereafter, the trained machine learning system may generate a revised dataset including at least the one or more data types 556.

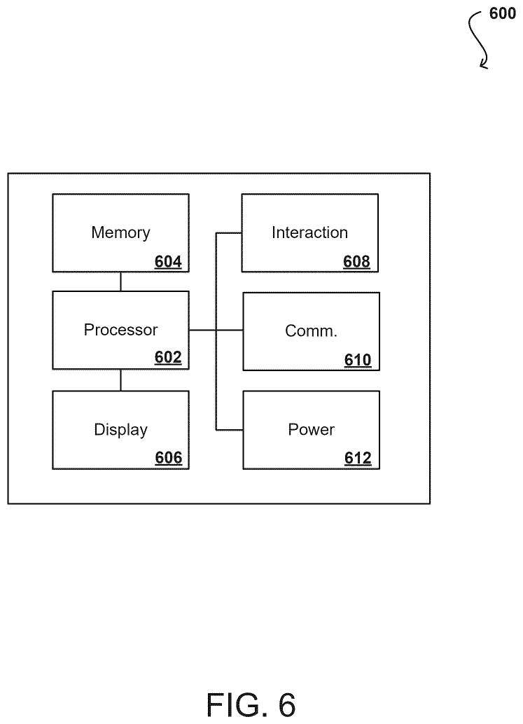

FIG. 6 illustrates a set of general components of an example computing device 600. In this example, the device includes a processor 602 for executing instructions that can be stored in a memory 604. The device can include many types of memory, data storage, or non-transitory computer-readable storage media, such as a first data storage for program instructions for execution by the processor 602, a separate storage for images or data, a removable memory for sharing information with other devices, etc. The device may optionally include a display element 606, such as a touch screen or liquid crystal display (LCD), although devices such as portable media players might convey information via other means, such as through audio speakers, and other devices may not include displays, such as server components executing within data centers, among other options. As discussed, the device in many embodiments will include at least one interaction component 608 able to receive input from a user. This input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 600 of FIG. 6 can include one or more network interface or communication components 610 for communicating over various networks, such as a Wi-Fi, Bluetooth, RF, wired, or wireless communication systems. The device may be configured to communicate with a network, such as the Internet, and may be able to communicate with other such devices. The device will also include one or more power components 612, such as power cords, power ports, batteries, wirelessly powered or rechargeable receivers, and the like.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

Embodiments may also be described in view of the following clauses:

1. A computer-implemented method, comprising:
receiving at least a portion of a dataset and a prompt associated with a target data type output;
generating, based at least in part on attributes of a target date data type associated with the target data type output, a model output using one or more trained machine learning models;
comparing one or more model output features to one or more target data type output features;
determining the one or more model output features are not sufficiently similar to the one or more target data type output features;
modifying one or more of the one or more trained machine learning models or the prompt;
generating an updated model output after modifying one or more of the one or more trained machine learning models or the prompt;
determining one or more updated model output features are sufficiently similar to the one or more target data type output features; and
generating a revised dataset using at least the updated model output.

2. The computer-implemented method of clause 1, wherein the one or more trained machine learning models include a transformer-based generative artificial intelligence model.

3. The computer-implemented model of clause 1, wherein the target data type output includes at least a label associated with information within the dataset and an output schema.

4. The computer-implemented method of clause 1, wherein the dataset includes free-form textual data.

5. The computer-implemented method of clause 1, further comprising:
identifying a set of data entries, within the dataset, corresponding to the attributes, wherein at least a first portion of the set of data entries uses a different data schema than a second portion of the set of data entries;
determining the first portion of the set of data entries and the second portion of the set of data entries each correspond to the target data type output; and
modifying individual data schema for the first portion of the set of data entries and the second portion of the set of data entries to corresponds to a target data schema of the target data type output.

6. The computer-implemented method of clause 1, wherein comparing the one or more model output features to one or more target data type output features includes at least one of a linear comparison, a non-linear comparison, or a machine-learning comparison.

7. The computer-implemented method of clause 1, wherein the dataset corresponds to electronic health records.

8. The computer-implemented method of clause 1, wherein the revised model output includes data entries having a common output format.

9. A processor, comprising:
one or more circuits to:
   generate, responsive to a first prompt, a set of permutations associated with a target data type within a dataset;
   receive one or more corrections associated with the set of permutations;
   generate, responsive to a second prompt, a second set of permutations associated with the target datatype within the dataset; and
   generate, responsive to a third prompt, an updated dataset associated with the target data type, wherein the updated dataset includes at least one modified data entry of the target data type providing a different presentation type than a storage type.

10. The processor of clause 9, wherein the one or more circuits are further to:
determine the second set of permutations exceeds a threshold similarity criterion accuracy level based on one or more similarity metrics.

11. The processor of clause 9, wherein the one or more circuits are further to:
provide a set of generative rationale associated with the first set of permutations, wherein the generative rationale includes at least one attribute-value pair corresponding to the target data type.

12. The processor of clause 9, wherein each data entry for the target data type in the updated dataset includes a common output format.

13. The processor of clause 9, wherein the set of permutations, the second set of permutations, and the updated dataset are generated using one or more trained machine learning models.

14. The processor of clause 13, wherein the one or more trained machine learning models include at least one transformer-based generative artificial intelligence model.

15. The processor of clause 9, wherein the dataset includes free-form textual data associated with electronic health records.

16. A computer-implemented method, comprising:
generating, responsive to a first prompt, a set of permutations associated with a target data type within a dataset;
receiving one or more corrections associated with the set of permutations;
generating, responsive to a second prompt, a second set of permutations associated with the target datatype within the dataset; and
generating, responsive to a third prompt, an updated dataset associated with the target data type, wherein the updated dataset includes at least one modified data entry of the target data type providing a different presentation type than a storage type.

17. The computer-implemented method of clause 16, further comprising:
determining the second set of permutations exceeds a threshold accuracy level based on one or more similarity metrics.

18. The computer-implemented method of clause 16, further comprising:
providing a set of generative rationale associated with the first set of permutations, wherein the generative rationale includes at least one attribute-value pair corresponding to the target data type.

19. The computer-implemented method of clause 16, wherein each data entry for the target data type in the updated dataset includes a common output format.

20. The computer-implemented method of clause 16, wherein the set of permutations, the second set of permutations, and the updated dataset are generated using one or more trained machine learning models.

21. A computer-implemented method, comprising:
receiving at least a portion of a dataset and a prompt associated with a target data type output;
generating, based at least in part on attributes of a target date data type associated with the target data type output, a model output using one or more trained machine learning models;
comparing one or more model output features to one or more target data type output features;
determining the one or more model output features are not sufficiently similar to the one or more target data type output features;
modifying one or more of the one or more trained machine learning models or the prompt;
generating an updated model output after modifying one or more of the one or more trained machine learning models or the prompt;
determining one or more updated model output features are sufficiently similar to the one or more target data type output features; and
generating a revised dataset using at least the updated model output.

22. The computer-implemented method of clause 21, wherein the one or more trained machine learning models include a transformer-based generative artificial intelligence model.

23. The computer-implemented model of any of clauses 21 or 22, wherein the target data type output includes at least a label associated with information within the dataset and an output schema.

24. The computer-implemented method of any of clauses 21-23, wherein the dataset includes free-form textual data.

25. The computer-implemented method of any of clauses clause 21-24, further comprising:
identifying a set of data entries, within the dataset, corresponding to the attributes, wherein at least a first portion of the set of data entries uses a different data schema than a second portion of the set of data entries;
determining the first portion of the set of data entries and the second portion of the set of data entries each correspond to the target data type output; and
modifying individual data schema for the first portion of the set of data entries and the second portion of the set of data entries to corresponds to a target data schema of the target data type output.

26. The computer-implemented method of any of clauses 21-25, wherein comparing the one or more model output features to one or more target data type output features includes at least one of a linear comparison, a non-linear comparison, or a machine-learning comparison.

27. The computer-implemented method any of clauses 21-26, wherein the dataset corresponds to electronic health records.

28. The computer-implemented method of any of clauses 21-27, wherein the revised model output includes data entries having a common output format.

29. A processor, comprising:
one or more circuits to:
   generate, responsive to a first prompt, a set of permutations associated with a target data type within a dataset;
   receive one or more corrections associated with the set of permutations;
   generate, responsive to a second prompt, a second set of permutations associated with the target datatype within the dataset; and
   generate, responsive to a third prompt, an updated dataset associated with the target data type, wherein the updated dataset includes at least one modified data entry of the target data type providing a different presentation type than a storage type.

30. The processor of clause 29, wherein the one or more circuits are further to:
determine the second set of permutations exceeds a threshold similarity criterion accuracy level based on one or more similarity metrics.

31. The processor of any of clauses 29 or 30, wherein the one or more circuits are further to:
provide a set of generative rationale associated with the first set of permutations, wherein the generative rationale includes at least one attribute-value pair corresponding to the target data type.

32. The processor of any of clauses 29-31, wherein each data entry for the target data type in the updated dataset includes a common output format.

33. The processor of any of clauses 29-32, wherein the set of permutations, the second set of permutations, and the updated dataset are generated using one or more trained machine learning models.

34. The processor of clause 33, wherein the one or more trained machine learning models include at least one transformer-based generative artificial intelligence model.

35. The processor of any of clauses 29-34, wherein the dataset includes free-form textual data associated with electronic health records.

36. A computer-implemented method, comprising:
generating, responsive to a first prompt, a set of permutations associated with a target data type within a dataset;
receiving one or more corrections associated with the set of permutations;
generating, responsive to a second prompt, a second set of permutations associated with the target datatype within the dataset; and
generating, responsive to a third prompt, an updated dataset associated with the target data type, wherein the updated dataset includes at least one modified data entry of the target data type providing a different presentation type than a storage type.

37. The computer-implemented method of clause 36, further comprising:
determining the second set of permutations exceeds a threshold accuracy level based on one or more similarity metrics.

38. The computer-implemented method of any of clauses 36 or 37, further comprising:
providing a set of generative rationale associated with the first set of permutations, wherein the generative rationale includes at least one attribute-value pair corresponding to the target data type.

39. The computer-implemented method of any of clauses 36-38, wherein each data entry for the target data type in the updated dataset includes a common output format.

40. The computer-implemented method of any of clauses 36-39, wherein the set of permutations, the second set of permutations, and the updated dataset are generated using one or more trained machine learning models.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer-implemented method, comprising:
receiving at least a portion of a dataset and a prompt associated with a target data type output;
generating, based at least in part on attributes of a target data type associated with the target data type output, a model output using one or more trained machine learning models, the model output including individual instances of the target data type output within the portion of the dataset and respective features for the individual instances of the target data type output;
comparing the respective features for the individual instances to one or more target data type output features;
determining the respective features for at least one of the individual instances of the target data type are not sufficiently similar to the one or more target data type output features;
generating a plurality of second prompts configured to extract information from at least the portion of the dataset having the target data type output;
generating a plurality of updated model outputs using the plurality of second prompts, the plurality of updated model outputs including a revised set of individual instances of the target data type output within the portion of the dataset and respective updated features for the revised set of individual instances of the target data type output;
determining the respective updated features for the revised set of individual instances are sufficiently similar to the one or more target data type output features;
determining a final prompt, from the plurality of second prompts, associated with the target data type output, based at least in part on the plurality of updated model outputs;
generating a revised dataset using the final prompt, the revised dataset including the respective updated features for the revised set of individual instances and removing other features not associated with the revised set of individual instances; and
updating the one or more trained machine learning models based, at least in part, on the final prompt and the revised dataset to target the respective updated features for a given input prompt, the given input prompt including a common representation for one or more dependencies associated with the final prompt, and wherein the given input prompt includes fewer terms than the final prompt.

2. The computer-implemented method of claim 1, wherein the one or more trained machine learning models include a transformer-based generative artificial intelligence model.

3. The computer-implemented model of claim 1, wherein the target data type output includes at least a label associated with information within the dataset and an output schema.

4. The computer-implemented method of claim 1, wherein the dataset includes free-form textual data.

5. The computer-implemented method of claim 1, further comprising:
identifying a set of data entries, within the dataset, corresponding to the attributes, wherein at least a first portion of the set of data entries uses a different data schema than a second portion of the set of data entries;
determining the first portion of the set of data entries and the second portion of the set of data entries each correspond to the target data type output; and
modifying individual data schema for the first portion of the set of data entries and the second portion of the set of data entries to correspond to a target data schema of the target data type output.

6. The computer-implemented method of claim 1, wherein comparing the respective features for at least one of the individual instances of the target data type to one or more target data type output features includes at least one of a linear comparison, a non-linear comparison, or a machine-learning comparison.

7. The computer-implemented method of claim 1, wherein the dataset corresponds to electronic health records.

8. The computer-implemented method of claim 1, wherein the revised dataset includes data entries having a common output format.

9. A processor, comprising:
one or more circuits to:
generate, responsive to a first prompt, a set of permutations associated with a target data type within a dataset;
receive one or more corrections associated with the set of permutations configured to adjust identification features for the target data type to identify at least one additional data entry within the dataset;
generate, responsive to a second prompt configured to force one or more hallucinations, a second set of permutations associated with the target datatype within the dataset, the second set of permutations including one or more additional identification features compared to the set of permutations; and
generate, responsive to a third prompt, an updated dataset associated with the target data type, wherein the updated dataset includes at least one modified data entry of the target data type providing a different presentation type than a storage type.

10. The processor of claim 9, wherein the one or more circuits are further to:
determine the second set of permutations exceeds a threshold similarity criterion based on one or more similarity metrics, wherein the second set of permutations is associated with a plurality of storage types, including the storage type, corresponding to a textual representation within the dataset.

11. The processor of claim 9, wherein the one or more circuits are further to:
provide a set of generative rationale associated with the first set of permutations, wherein the generative rationale includes at least one attribute-value pair corresponding to the target data type.

12. The processor of claim 9, wherein each data entry for the target data type in the updated dataset includes a common output format.

13. The processor of claim 9, wherein the set of permutations, the second set of permutations, and the updated dataset are generated using one or more trained machine learning models.

14. The processor of claim 13, wherein the one or more trained machine learning models include at least one transformer-based generative artificial intelligence model.

15. The processor of claim 9, wherein the dataset includes free-form textual data associated with electronic health records.

16. A computer-implemented method, comprising:
generating, responsive to a first prompt, a set of permutations associated with a target data type within a dataset;
receiving one or more corrections associated with the set of permutations configured to adjust identification features for the target data type to identify at least one additional data entry within the dataset;
generating, responsive to a second prompt configured to force one or more hallucinations, a second set of permutations associated with the target datatype within the dataset, the second set of permutations including one or more additional identification features compared to the set of permutations; and
generating, responsive to a third prompt, an updated dataset associated with the target data type, wherein the updated dataset includes at least one modified data entry of the target data type providing a different presentation type than a storage type.

17. The computer-implemented method of claim 16, further comprising:
determining the second set of permutations exceeds a threshold accuracy level based on one or more similarity metrics, wherein the second set of permutations is associated with a plurality of storage types, including the storage type, corresponding to a textual representation within the dataset.

18. The computer-implemented method of claim 16, further comprising:
providing a set of generative rationale associated with the first set of permutations, wherein the generative rationale includes at least one attribute-value pair corresponding to the target data type.

19. The computer-implemented method of claim 16, wherein each data entry for the target data type in the updated dataset includes a common output format.

20. The computer-implemented method of claim 16, wherein the set of permutations, the second set of permutations, and the updated dataset are generated using one or more trained machine learning models.
